(19) United States
(12) Patent Application Publication
(10) Pub. No.: US 2008/0237368 A1
(43) Pub. Date: Oct. 2, 2008

(54) Ozonated Water Dispenser

(75) Inventors: Steve L. Hengsperger, Lakeshore (CA); Justin L. Namespetra, Essex (CA); Christopher B. Caldwell, Stoney Creek (CA); Richard S. Zulik, Beamsville (CA)

Correspondence Address: BORDEN LADNER GERVAIS LLP;Anne Kinsman, WORLD EXCHANGE PLAZA, 100 QUEEN STREET SUITE 1100, OTTAWA, ON, K1P 1J9, CA

(73) Assignee: Tersano Inc., St. Catharines, ON (CA)

(21) Appl. No.: 11/908,849

(22) PCT Filed: Mar. 17, 2006
(86) PCT No.: PCT/CA06/00405

§ 371 Date: Mar. 14, 2008

Related U.S. Application Data
(60) Provisional application No. 60/662,788, filed on Mar. 18, 2005.

(51) Int. Cl. B05B 1/20; E01H 3/02

(52) U.S. Cl. 239/172; 239/159

(57) ABSTRACT

An ozonated water dispenser allows a user to kill bacteria and microbiological organisms on their hands or other objects. The dispenser includes a reservoir, a pump, and an ozonated water delivery means downstream from the pump to dispense pressurized ozonated water in a fine mist. The delivery means includes a mister and a control valve, such as a solenoid, to restrict water flow in a water line to build up water pressure between the pump and the control valve to overcome the mister's cracking pressure. A water ozonation means is provided downstream from the ozonated water delivery means, and in communication with an inlet of the reservoir to recirculate water. This dispenser uses regular tap water and can be employed as an alternative to a sanitizing gel, or when use of a gel is not practical or desirable, such as for sanitizing fresh produce after its purchase.

### CROSS REFERENCE TO RELATED APPLICATIONS

This application claims the benefit of priority of U.S. Provisional Patent Application No. 60/662,788 filed Mar. 18, 2005, which is incorporated herein by reference.

### FIELD OF THE INVENTION

The present invention relates generally to water sanitization and ozonation. More particularly, the present invention relates to a device for dispensing ozonated water for sanitization.

### BACKGROUND OF THE INVENTION

Many bacteria and microbiological organisms can be transmitted via a handshake or other physical contact. This can be of particular concern to workers in the health care and service industries, and other environments where frequent contact is made with people who may be carrying bacteria. Proper hand-washing techniques are, however, rarely followed, resulting in sometimes inadequate protection from bacteria and microbiological organisms. This is often a concern for individuals, particularly for those working in service industries, both in terms of adherence to health standards and regulations as well as in terms of maintaining their reputation.

Some gels can provide disinfecting performance in situations where hand washing is not possible or practical. Such gels typically include an alcohol, such as ethyl alcohol, to essentially evaporate bacteria. These gels are often sold in plastic bottles to consumers. Wall-mounted dispensing units are sometimes provided in public areas, such as hospitals. However, a disadvantage exists in maintaining a supply of the gel, both in terms of the cost of replacing the gel itself as well as in terms of the manpower cost for someone to physically monitor and refill containers and/or dispensers.

Moreover, there are situations where it is desirable to sanitize certain items, but the use of a sanitizing gel is not practical or desirable. One such example occurs when a person has just purchased fresh produce and desires to sanitize the produce. Ozonated water can be used for sanitization. Some known approaches are directed towards sanitizing drinking water in a portable container or reservoir.

One known approach provides ozonated water to sanitize hands and/or other items by providing ozonated water in a sink. Another approach dispenses ozonated water by opening a solenoid valve. However, many such known approaches provide ozonated water in a non-pressurized manner, or in a manner that requires subsequent drying of the hands or further touching of the device, each of which can reduce or negate the sanitizing effect of the ozonated water.

It is, therefore, desirable to provide a solution that provides a device for facilitating sanitizing, such as hand sanitizing, at a low cost and good performance.

### SUMMARY OF THE INVENTION

It is an object of the present invention to obviate or mitigate at least one disadvantage of previous sanitizing approaches.

In an aspect, the present invention provides an ozonated water dispenser including a reservoir for holding water, having an inlet and an outlet, and a pump connected to the outlet of the reservoir. An ozonated water delivery means is provided downstream from the pump to receive water from the pump and to dispense pressurized ozonated water, preferably in a fine mist. The ozonated water delivery means includes a mister and a control valve. The control valve is used to restrict water flow in a water line in response to a dispensing request to build water pressure between the pump and the control valve to overcome a cracking pressure of the mister. A water ozonation means is provided downstream from the ozonated water delivery means, and in communication with the inlet of the reservoir to recirculate water. The water ozonation means includes an ozone generator to convert oxygen into ozone. The water ozonation means also includes an ozone contacting device to mix the ozone with the water, and an off-gas unit to remove air and undissolved ozone.

The dispenser can further include an activation switch, such as an optical sensor, in electrical communication with the ozonated water delivery means to initiate the dispensing request. The ozonated water delivery means can dispense water in response to actuation of the activation switch.

The control valve can include a solenoid. In that case, the solenoid can close the water line in response to the dispensing request, and can open the water line in response to termination of the dispensing request. The solenoid can be integral with the mister.

The mister can be a dripless mister, such as with a cracking pressure of about 20 psi, or a non-dripless mister, such as with a cracking pressure of about 10 psi. With a non-dripless mister, the dispenser can further include a basin provided below the ozonated water delivery means to receive excess ozonated water after delivery. An outlet of the basin can provide water back to the inlet of the reservoir.

The ozonated water delivery means can further include a dedicated pump to independently draw water out of the reservoir. The dedicated pump can be connected to the reservoir by a second independent water line.

The dispenser can further include a water ozonation control means to automatically shut off the water ozonation means in response to expiry of an ozone cycle time period, or to control the water ozonation means in response to a sensed ozone concentration level. The water ozonation control means can: automatically turn on the water ozonation means in response to a determination that the sensed ozone concentration level is below an ozone concentration threshold; and automatically shut off the water ozonation means in response to a determination that the sensed ozone concentration level exceeds an ozone concentration limit. The dispenser can further include an ozone concentration sensor provided near the reservoir to sense an ozone concentration in the water.

The dispenser can further include a filling inlet and a flushing outlet. The filling inlet is connected to, or integral with, the reservoir to receive water from an external water source. The flushing outlet is connected to, or integral with, the reservoir to flush water out of the reservoir. The dispenser can further include check valves at an inlet and outlet of the ozone generator to prevent residual ozone gas diffusion to atmosphere when the dispenser is not running.

The dispenser can be provided in a housing, and can be either entirely or partially provided in a wall-mountable housing. The housing and the reservoir can include mating portions to self-align the reservoir in the housing.

In another aspect, the present invention provides an ozonated water dispenser including a reservoir for holding water, a water delivery pump connected to the reservoir via a water delivery path, and a water ozonation pump connected to the reservoir in a water ozonation path. The dispenser includes an ozonated water delivery means provided upstream from the water delivery pump in the water delivery path to receive water from the water delivery pump and to dispense pressurized ozonated water. The ozonated water delivery means includes a mister to dispense ozonated water in a mist. The water delivery pump turns on in response to a dispensing request to overcome a cracking pressure of the mister. The dispenser also includes a water ozonation means provided downstream from the ozonated water delivery means, and being in recirculating communication with the reservoir to recirculate water. The water ozonation means can include an ozone generator to convert oxygen into ozone, an ozone contacting device to mix the ozone with the water, and an off-gas unit to remove air and undissolved ozone.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a mechanical and electrical system diagram of an ozonated water dispenser according to an embodiment of the present invention;

FIG. 2 is a mechanical and electrical system diagram of an ozonated water dispenser according to another embodiment of the present invention;

FIG. 3 is a front perspective view of an ozonated water dispenser according to an embodiment of the present invention;

FIG. 4 illustrates the ozonated water dispenser of FIG. 2 with the reservoir removed from the housing;

FIG. 5 is a bottom perspective view of the ozonated water dispenser of FIG. 3;

FIG. 6 is a rear perspective view of the ozonated water dispenser of FIG. 3;

FIG. 7 is a front perspective view of an ozonated water dispenser according to another embodiment of the present invention;

FIG. 8 is a rear perspective view of the dispenser of FIG. 7 with a back portion of the housing removed; and

FIG. 9 is a front perspective view of an ozonated water dispenser according to a further embodiment of the present invention with the reservoir removed from the housing.

### DETAILED DESCRIPTION

Generally, the present invention provides an ozonated water dispenser that allows a user to kill bacteria and microbiological organisms on their hands or other objects. The dispenser includes a reservoir, a pump, and an ozonated water delivery means downstream from the pump to dispense pressurized ozonated water in a fine mist. The delivery means includes a mister and a control valve, such as a solenoid, to restrict water flow in a water line to build up water pressure between the pump and the control valve to overcome the mister's cracking pressure. A water ozonation means is provided downstream from the ozonated water delivery means, and in communication with an inlet of the reservoir to recirculate water. The water ozonation means includes an ozone generator, an ozone contacting device, and an off-gas unit. The dispenser can alternatively include two pumps: a water delivery pump and a water ozonation pump. This dispenser uses regular tap water and can be employed as an alternative to a sanitizing gel, or in situations where use of a sanitizing gel is not practical or desirable, such as for sanitizing fresh produce after its purchase.

The system of the present invention provides an advantage over existing gel-based wall mounted hand sanitizers by only requiring regular tap water to function, thus reducing the cost of replacing the gels or creams on a regular basis.

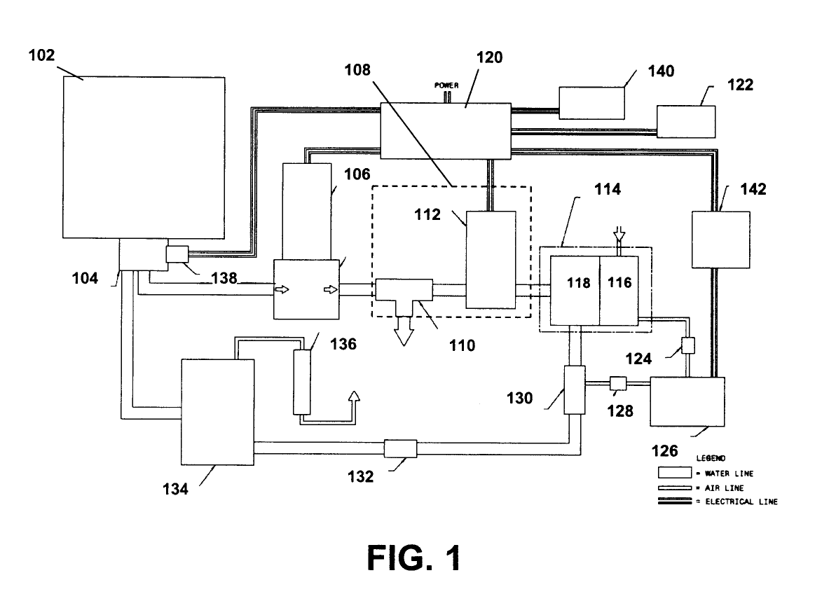

FIG. 1 is a mechanical and electrical system diagram of an ozonated water delivery system, such as a hand sanitization system, according to an embodiment of the present invention. In discussions of this figure, the terms “after” and “before” are used with respect to the water or air flow within the system. The direction of water flow is illustrated at pump motor 106, whereas the direction of air flow is illustrated at air dryer 116.

An exemplary embodiment is shown in FIG. 1. The ozonated water dispenser, or hand sanitization system, is essentially an improvement and adaptation of an ozonation system that can be used for ozonating water. It is a re-circulating system that converts regular tap water into ozonated water. Some embodiments use many of the same components as other ozonation systems such as described in commonly assigned International (PCT) Patent Application No. WO 2004/063100 published on Jul. 29, 2004 and entitled “Sanitization System And System Components Producing Ozonated Liquid”, as well as Application No. WO 2004/113232 published on Dec. 29, 2004 and entitled “System And Containers For Water Filtration And Item Sanitization”, both of which are incorporated herein by reference.

There are a few main differences or changes when comparing those other ozonation systems and the ozonated water dispensation system according to embodiments of the present invention. These differences include:

1) In the water line of the ozonated water dispenser, an ozonated water delivery means (provided in one embodiment as a mister and a solenoid) is placed between the pump and the ozone generator, and provides pressurized ozonated water.

2) An activation switch, such as an optical sensor, connected to the control board, is preferably provided for a user to indicate a desire to obtain ozonated water from the dispenser.

3) The exterior housing has been modified to make the product more aesthetically pleasing; however, the system could be incorporated into any exterior shell.

4) The logic of the control board has been revised for the new application.

Elements involved directly with water flow in the water line will be described first, followed by a description of elements involved with the electronics and with the air line.

A reservoir 102 is provided for containing water that is to be, or is being, sanitized/purified. The reservoir 102 is typically any type of container for holding water. In embodiments of the present invention, this reservoir can be a type of holding reservoir that holds water drawn from a “tap water” source, or any other external water source or water line. A fluid transfer port or valve 104 is provided, preferably at the interface of the reservoir 102 with a base unit incorporating the other elements of the system according to an embodiment of the present invention. The fluid transfer valve 104, or fluid control port or liquid interface, allows the control of fluids, and in particular, but not limited to, the control of fluids into and out of the reservoir, which can allow the reservoir to be removed without leaking.

The flow into and out of the reservoir or container can occur simultaneously or sequentially. In the case of simultaneous outflow and inflow, water is taken from the reservoir 102, processed, and pumped back to the reservoir. This is preferably done in such a way that the fluid level in the reservoir is maintained during processing (i.e. the fluid is not drained from the reservoir, processed and then pumped back into the reservoir). The fluid transfer valve 104 can be implemented in any number of ways, such as by way of separate check valves for inflow and outflow, or a single double check valve for both inflow and outflow. The double check valve arrangement allows water to flow out of and into the reservoir simultaneously while using a single connection point.

Water flows from the reservoir 102, through the fluid transfer valve 104 to a pump motor 106 provided after the reservoir 102 and connected to the outlet of the reservoir to draw water from it. Although the pump head and motor functions can be separated, they are typically implemented in a unitary motor/pump assembly, such as the pump motor 106, and will be discussed as such herein, keeping in mind that other implementations are possible. The electronics are typically connected to the motor portion, but the pump and motor are interconnected.

Embodiments of the present invention provide an ozonated water delivery means 108 between the pump motor 106 and an optional replaceable cartridge 114. The ozonated water delivery means 108 can provide the water in a pressurized manner at a flow rate similar to a typical household tap. A basin or sink can be provided below the system in order to receive excess water after it has passed over a user's hands or other item to be sanitized. If a basin or drain is used, any ozonated water that falls into the basin can go to wastewater, or can alternatively be fed back into the system, possibly after a filtering step.

In a presently preferred embodiment, the ozonated water delivery means 108 includes a mister 110 and a control valve 112. The mister 110 is a means for providing a mist of water, also known as a water mister or atomizer, which includes a small closable opening, such as a valve. When the mister is pressurized beyond a set value or threshold pressure, the small valve will open, causing a mist of water to be sprayed out. The set value is also known as a “cracking pressure”, and can be about 20 psi for a dripless mister, or about 10 psi for a non-dripless mister. Since the system is a re-circulating system, the pressure in the system is designed not to go beyond the cracking pressure of the mister 110 until a deliberate action is taken to build the pressure in the system.

Not only is less water used with such a mister 110 than with other possible approaches, but there is no longer a need for a basin or sink in all instances. This is because the mist is provided, preferably as a fine mist, such that water that does not come into contact with a person's hands or an object to be sanitized simply evaporates. Without the need for a basin or drain, the ozonated water dispenser can advantageously be provided as a portable unit. This also makes it easier to install a wall-mountable ozonated water dispenser according to an embodiment of the present invention in a plurality of useful locations.

The mister 110 can preferably be implemented as a “dripless” mister. Dripless misters are known to have a higher cracking pressure than standard misters, but they do not drip when mist is not being delivered, which is an advantage over non-dripless misters. With a non-dripless mister, a basin or drain can be provided as part of, in conjunction with, or below the ozonated water dispenser the dispenser to receive excess ozonated water after delivery. An outlet of the basin can provide water back to the inlet of the reservoir. Although an embodiment is shown of an ozonated water delivery means 108 including separate mister 110 and control valve 112, it is to be understood that the solenoid could be integrated into the mister.

The control valve, or water line controller, 112 can be any manual, automatic, electrical, mechanical, or electromechanical means to restrict water flow in the water line to overcome the cracking pressure of the mister 110. In this particular embodiment, the control valve 112 is a solenoid. In an embodiment to be described later, the control valve is another pump. However, the control valve can be any means that restricts water flow in the water line, such as a balloon to pinch the water line.

A particular implementation of this deliberate action is the closing of the solenoid 112, which is preferably initiated by a dispensing request, and which closes the water line. Other deliberate actions are possible, such as turning on a dedicated pump in response to actuation of an activation means. In such a case, the ozonated water delivery means can further include a dedicated pump (not shown) to independently draw water out of the reservoir. The dedicated pump can be connected to, or in fluid communication with, the reservoir by a second independent water line, either instead of or in addition to the existing water line.

The ozonated water delivery means 108 is preferably in communication with a control board 120. The control board 120 can close the control valve, or solenoid, in response to a user's indication to the unit they want the mister to mist. When the solenoid 112 is closed, the water line is closed and the pump 106 continues to run and build pressure in the line between the pump 106 and solenoid 112. This raises the pressure in the mister 110 beyond its cracking pressure and a fine mist of water is dispensed to the user. When a user indicates they do not want any more water to be misted, the control board 120 opens the solenoid 112 again, the water line opens, and the pressure in the mister 110 drops below its cracking pressure, causing the mist to stop.

In other words, in an aspect, the present invention provides an ozonated water dispenser including a reservoir for holding water, having an inlet and an outlet, and a pump connected to the outlet of the reservoir. An ozonated water delivery means is provided downstream from the pump to receive water from the pump and to dispense pressurized ozonated water, preferably in a fine mist. The ozonated water delivery means includes a mister and a control valve. The control valve, such as a solenoid, is used to restrict water flow in a water line in response to a dispensing request to build water pressure between the pump and the control valve to overcome a cracking pressure of the mister. A water ozonation means is provided downstream from the ozonated water delivery means, and in communication with the inlet of the reservoir to recirculate water. The water ozonation means includes an ozone generator to convert oxygen into ozone. The oxygen can be taken from atmospheric air, or can be provided by a replaceable oxygen cartridge (not shown), or any other suitable means or oxygen source. The water ozonation means also includes an ozone contacting device to mix the ozone with the water, and an off-gas unit to remove air and undissolved ozone. The solenoid can open, and can open the water line, in response to termination of the dispensing request.

The dispenser can further include an activation switch, such as an optical sensor, in electrical communication with the ozonated water delivery means to initiate the dispensing request. The ozonated water delivery means can dispense water in response to actuation of the activation switch. With respect to FIG. 1, an activation switch, or activation means, 122 is provided in communication with the control board 120. The activation switch 122 is for providing a signal to the control board 120 that the user wants ozonated water to be dispensed. The activation switch 122 can be implemented in any number of mechanical and/or electrical manners, such as a proximity switch, a mechanical switch, a push button, etc.

In a presently preferred embodiment, the activation switch 122 is an optical sensor. When a user places their hands at, in or near an activation location (such as under the mister spout), their hands will be within the range of the optical sensor 122, thus notifying the control board 120 that a user wishes to dispense a mist of water. At this point the control board 120 activates the solenoid 112 and the mist is dispensed as described above. Not only is the use of an optical sensor a user-friendly and intuitive implementation, it is also more hygienic than most other methods which require physical contact with an object that may itself carry bacteria or microbiological organisms.

A replaceable cartridge 114 can optionally be provided according to an embodiment of the present invention. The cartridge 114 can include an air dryer 116 for function in the air flow of the system and/or a water filter 118 for function in the water flow of the system. The structure and functions of the cartridge 114 are discussed in co-pending PCT Application No. ______ filed on Mar. 17, 2006 and entitled “Drinking Water Sanitization System Having Safety Features And Removable Filter”, which is incorporated herein by reference.

In terms of air circulation in the system, air can be drawn in from the atmosphere via the air dryer 116, and can then pass through an inlet valve 124, an ozone generator 126, an outlet valve 128, and an ozone contacting device, or mixing device, 130, such as a venturi.

The valves 124 and 128 co-operate to ensure that when the unit is not running, no (or little) residual ozone gas can diffuse out of the system to atmosphere. The outlet valve 128 prevents water from backing up into the ozone generator 126 via the ozone contacting device 130 when the unit is at rest with a reservoir, or attachment, on it. The ozone generator 126, which can be a corona-discharge type, converts oxygen (in air drawn from the atmosphere, or drawn from an ozone cartridge) into ozone. The ozone is mixed with the water in the ozone contacting device 130. The water ozone mixture then preferably passes through an ozone gas atomizer 132 before passing into an off-gas unit 134, which removes the air and undissolved ozone. The removed gas is directed to an ozone destructor 136, which converts ozone into oxygen and safely releases it into the atmosphere.

Sensors can preferably be provided in the system in order to provide enhanced functionality. An ozone concentration sensor 138 is preferably provided after the fluid transfer valve 104, and can be implemented as a mechanical switch, electronic sensor, or any other type of sensor or combination thereof.

The ozone concentration sensor 138, can monitor the ozone concentration level in the water in combination with a control board 120. The system can be turned off if the monitored ozone concentration level exceeds an upper ozone concentration limit, and can be turned on if the monitored ozone concentration level falls below a lower ozone concentration limit. Alternatively, a single ozone concentration level can function as both an upper limit and a lower limit. The system can be turned on in response to the sensed or measured ozone concentration level and/or in response to a timed ozonation cycle. Although a control board is described in relation to embodiments of the present invention, other types of controllers, such as combinations of logic gates or circuits (mechanical, optical, electronic, electromagnetic, fluidic, etc.), can be used to provide the desired control, sensing, or measurement.

The sensor 138 determines whether the sensed or measured ozone level is high enough with respect to the water in the reservoir. Such sensing or measurement is desirable since it takes a while for water in the reservoir to all mix together. The sensor 138 can be placed anywhere in the water line of the system. However, the position shown in FIG. 1 is a presently preferred location since it is always exposed to flowing water, resulting in continuous reading. Moreover, the ozone level at this point right after the reservoir will yield more accurate results with respect to “safe” indication, since the ozone concentration level is lower at that point than anywhere else in the water line.

In other words, the dispenser can further include an ozone concentration sensor provided near, or in contact with, the reservoir to sense an ozone concentration in the water. The dispenser can further include a water ozonation control means, such as a controller or a control board, to: automatically turn on the water ozonation means in response to a determination that a sensed ozone concentration level is below an ozone concentration threshold; automatically shut off the water ozonation means in response to determination that a sensed ozone concentration level exceeds an ozone concentration limit; and/or automatically shut off the water ozonation means in response to expiry of an ozone cycle time period. In an embodiment, the water ozonation control means can be implemented as part of a controller, such as a processor or a control board 120.

The control board 120 preferably includes a computer-readable memory storing statements and instructions for performing steps as described above. A display board 140 is preferably provided, in communication with the control board 120, to permit display of indications relating to the status of the system. For example, the display board 140 could display information relating to the monitored ozone concentration level detected by the sensor. The display board 140 can also display the measured ozone concentration level itself and whether the system is active or inactive, as well as how much time is left in the processing. A high voltage transformer 142 is preferably provided in order to take the power provided to the control board 120 and convert it to a power level suitable for driving the ozone generator 126.

As stated earlier, a system according to an embodiment of the present invention can be incorporated into any exterior housing. In fact, if the reservoir is to be attached to an external water line for automatic filling, much of the system can be housed in a recess in a wall, with only the ozonated water delivery means projecting out of the wall. Of course, a system according to another embodiment of the present invention could alternatively be implemented as a portable unit, not needing to be mounted to a wall or any other support. In such a case, the system can include, or provide access to, a power source (e.g. a battery, a power cord) in order to provide electrical power to the unit.

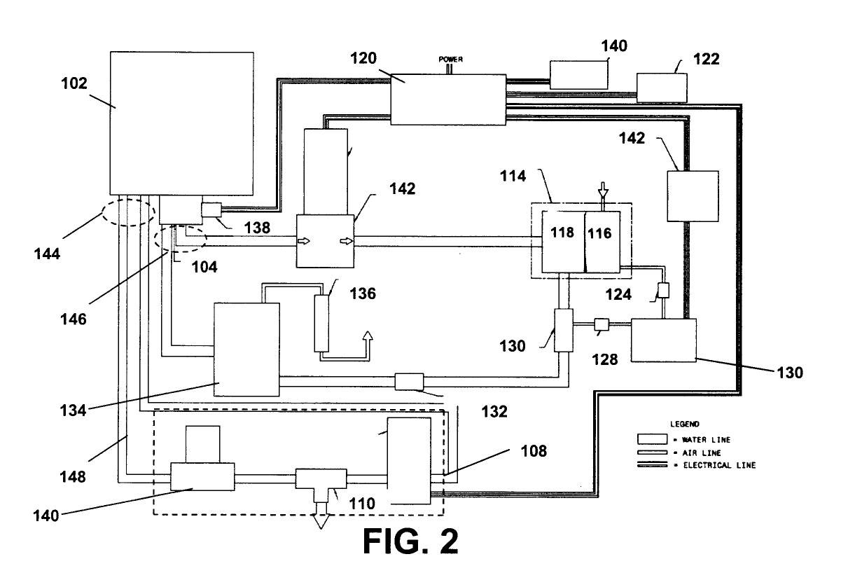

FIG. 2 is a mechanical and electrical system diagram of an ozonated water dispenser according to another embodiment of the present invention. While the system in FIG. 1 included a single pump that can deal with both water delivery and water ozonation, the embodiment in FIG. 2 includes two pumps: a water delivery pump 140 and a water ozonation pump 142. The two pumps are preferably connected to the reservoir via independent water paths, or water flow paths. In this case, the water delivery pump 140 is connected to the reservoir 102 via a dedicated water delivery path 144. The water ozonation pump 142 is separately connected to the reservoir 102 via a water ozonation path 146, which is separate and independent from the delivery water path 144.

In this embodiment, the water delivery pump 140 turns on in response to a dispensing request to overcome the cracking pressure of the mister and deliver ozonated water via the mister 110. As such, while a solenoid is shown in FIG. 2, the water delivery pump 140 acts as the control valve to restrict water flow in the water line, so the solenoid is actually not required. When the dispensing request is terminated, the water delivery pump 140 turns off and the mister closes. As such, a solenoid is not needed in this embodiment, since the water delivery pump provides the functionality that it provided as the control valve.

In FIG. 2, the water delivery pump is shown to be part of a recirculating water delivery path 144, the water delivery path including a forward line 148 and a return line 150. In an alternate embodiment, the water delivery pump can be connected to the mister by means of a dead end path, without a path back to the reservoir. In that case, the water delivery path 144 includes only the forward line 148 and does not include a return line.

In summary, in an aspect the present invention provides an ozonated water dispenser including a reservoir for holding water, a water delivery pump connected to the reservoir via a water delivery path, and a water ozonation pump connected to the reservoir in a water ozonation path. The dispenser includes an ozonated water delivery means provided upstream from the water delivery pump in the water delivery path to receive water from the water delivery pump and to dispense pressurized ozonated water. The ozonated water delivery means includes a mister to dispense ozonated water in a mist. The water delivery pump turns on in response to a dispensing request to overcome a cracking pressure of the mister. The dispenser also includes a water ozonation means provided downstream from the ozonated water delivery means, and being in recirculating communication with the reservoir to recirculate water. The water ozonation means can include an ozone generator to convert oxygen into ozone, an ozone contacting device to mix the ozone with the water, and an off-gas unit to remove air and undissolved ozone.

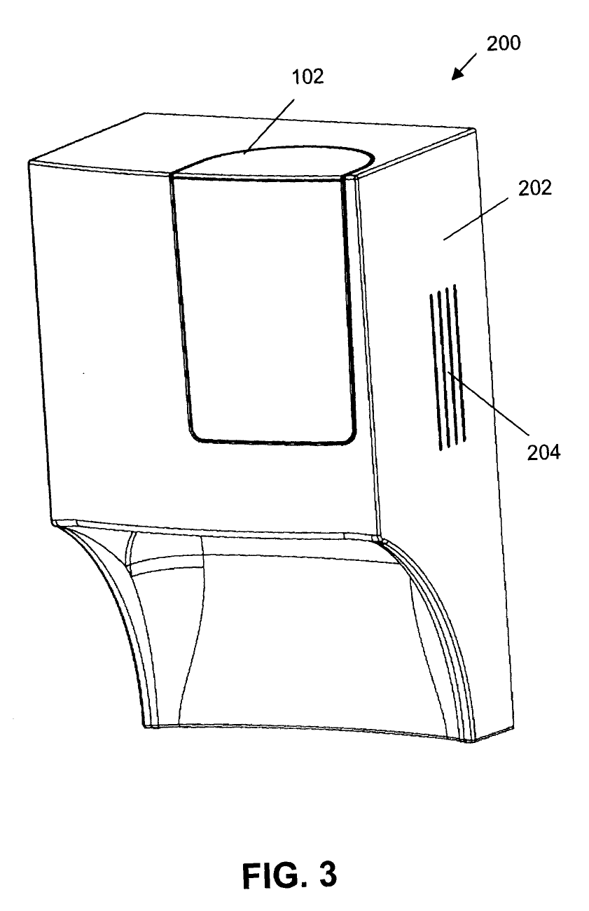

Wall-mounted hand sanitizer implementations of an ozonated water dispenser according to embodiments of the present invention will now be described. FIG. 3 is a front perspective view of an ozonated water dispenser according to an embodiment of the present invention. The dispenser, or hand sanitizer, 200 is shown as a wall mount unit that resembles hand dryers commonly found in many public restrooms. The externally visible parts of the system include the reservoir 102 and a housing 202, which preferably co-operate with each other to secure the reservoir in place. The housing houses the other elements of the system. Additional security can be provided by way of a lock or other securing means to prevent removal of, or tampering with, the reservoir.

In a presently preferred embodiment, the housing 202 can define air vents 204 to allow cooling of internal components of the dispenser, such as the pump and the ozone generator. Cooling can be achieved from ambient air traversing through the air vents and cooling the elements. Alternatively, a cooling fan (not shown) can be provided to keep the system cool and prevent over-heating. The cooling fan can be provided with, or be in communication with, a thermostat to selectively run the cooling fan in response to an air temperature within the housing or near certain components exceeding a threshold temperature.

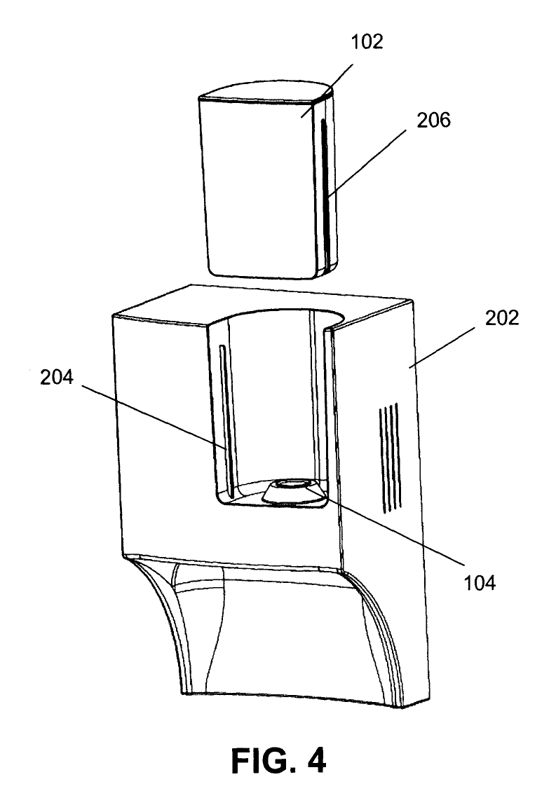

FIG. 4 illustrates the ozonated water dispenser of FIG. 3 with the reservoir removed from the housing. The housing 202 and reservoir 102 can include mating portions 204 and 206, respectively, to self-locate the reservoir in the housing. In FIG. 3, the mating portions 204 are locating strips and the mating portions 206 are locating grooves defined in the reservoir, though other implementations of mating portions are possible to join or removably interlock the two elements. A dual check valve 104, though not necessarily part of the housing itself, is a part of the system that can protrude through the housing and can be integrated with the housing. The reservoir has a mating portion to join with the dual check valve 104, sealing against each other and opening the check valve.

In other words, the dispenser can be provided in a housing, and either entirely or partially in a wall-mountable housing. The housing and the reservoir can include mating portions to self-align the reservoir in the housing. For example, the housing can include lips for receiving mating portions of the reservoir and can also include a ledge for gathering excess water.

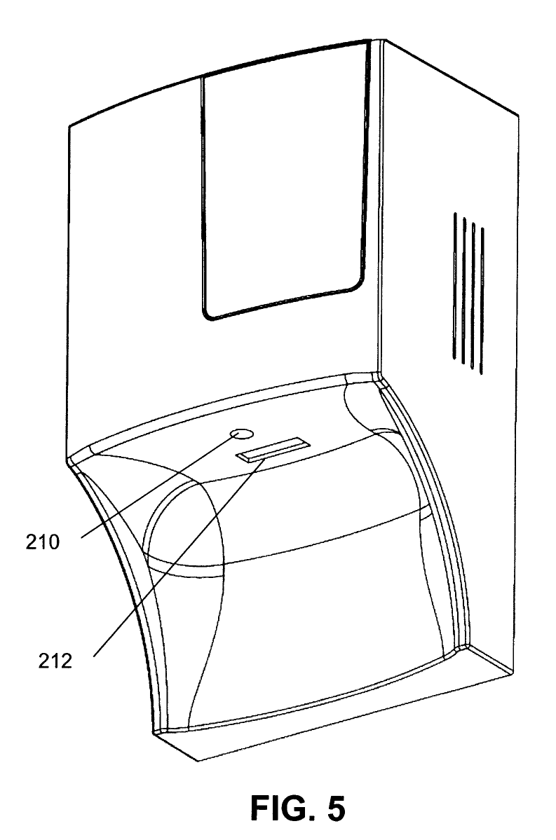

FIG. 5 is a bottom perspective view of the ozonated water dispenser of FIG. 3. The view in FIG. 5 shows a bottom surface of the housing defining a first opening 210 and a second opening 212. Preferably, the delivery end of the mister 110 is provided in the first opening 210, and the optical sensor 122 is provided in the second opening 212. The optical sensor is preferably placed closer to the wall-mountable portion of the dispenser in order to ensure that a user's hands (or an item to be sanitized) are placed underneath the mister when the optical sensor is activated.

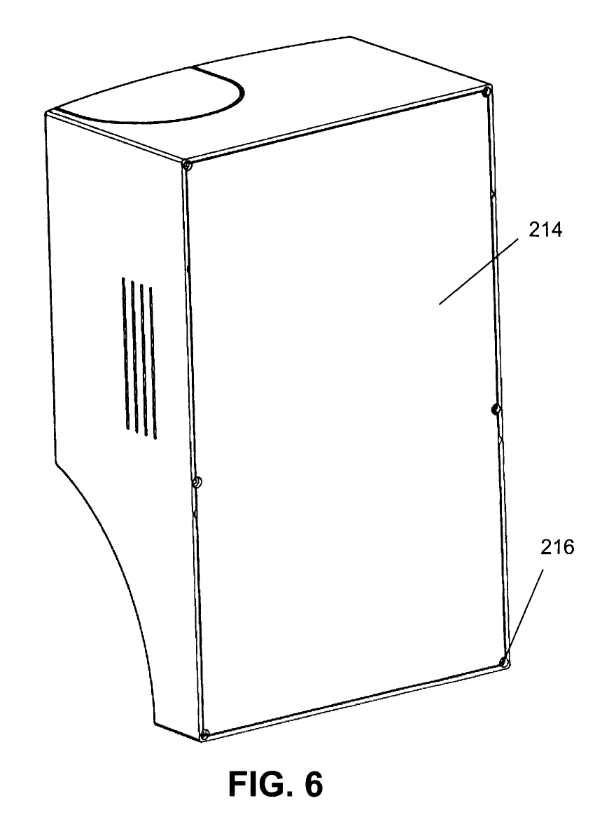

FIG. 6 is a rear perspective view of the ozonated water dispenser of FIG. 3. In this particular embodiment, a wall-facing plate 214 of the housing defines fastener holes 216 through which fasteners can secure the dispenser to a wall or other surface. The rest of the housing can preferably be removably secured to the wall-facing plate 214 of the housing 202 by a suitable securing means, such as by way of mating portions on the plate and the housing.

Although not explicitly shown in the figures, the rear of the ozonated water dispenser can include mounting means for mounting the dispenser to a wall or other surface. Of course, depending on how and where the dispenser is to be mounted, the mounting means can be provided on any surface of the housing. The reservoir could alternatively be provided against the rear wall of the housing, to facilitate provision of a water line to the reservoir. In such a case, a suitable means such as a check valve and/or electronics can be used to control the provision of water, preferably in response to a comparison of a measured water level to a desired or minimum water level. Though this is preferably done automatically, it is alternatively manually activated.

Testing has shown that it can be difficult to maintain an oxidation reduction potential in a volume of ozonated water. This can result in the possibility of bacteria growing in the ozonated water. Therefore, for embodiments of the present invention that are portable or wall-mounted without connection to a water line, it is preferable that the water in the reservoir be replaced or flushed periodically.

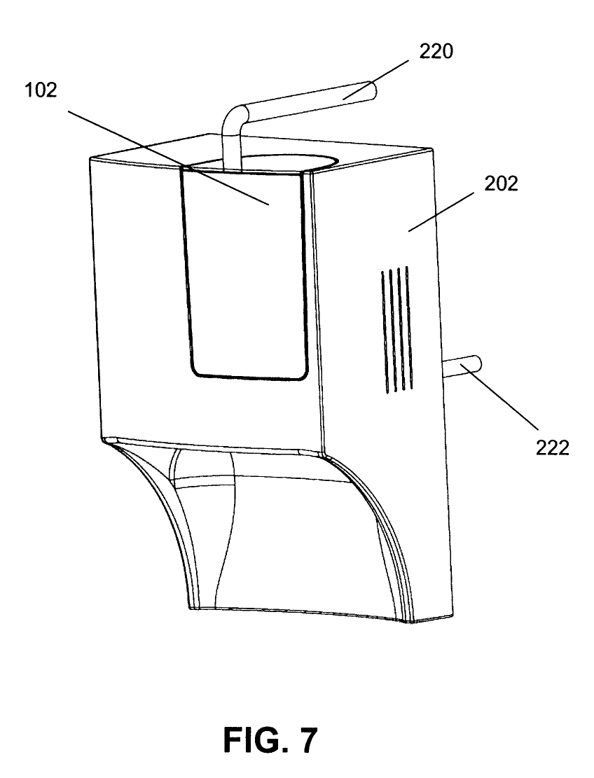

FIG. 7 is a front perspective view of an ozonated water dispenser according to another embodiment of the present invention, where the dispenser is attached directly to an external water source. The reservoir 102 is connected to, or includes, a filling inlet 220 to fill new water into the reservoir from the external water source, and a flushing outlet 222 to flush water to a drainwater pipe or other location.

For embodiments of the present invention that are wall-mounted and attached to a water line, the controller (described earlier) can include a means to automatically flush the water in the reservoir, preferably on a periodic basis, and preferably by controlling the pump. This can be achieved by running a program to compare a time since last system flush to a threshold time, and initiating the automatic flushing when the time since last system flush approaches or exceeds the threshold time. The reservoir can include a water level sensor (not shown) for opening a valve in communication with the filling inlet to refill the reservoir if the water level falls below a certain level.

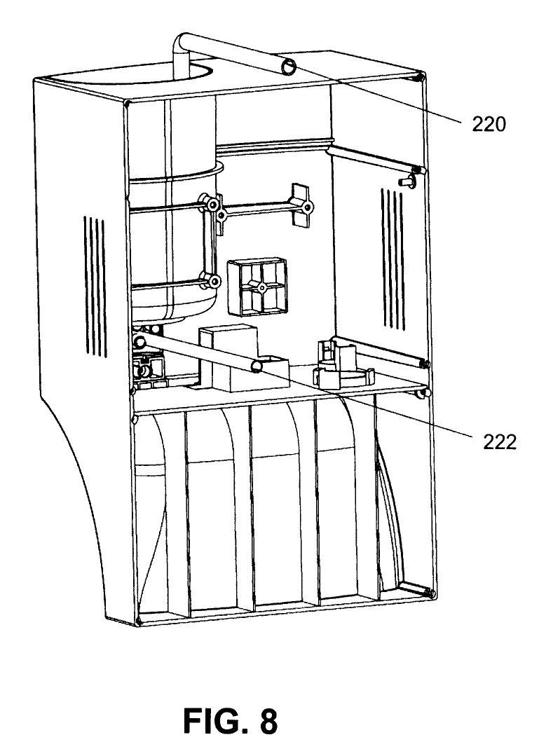

FIG. 8 is a rear perspective view of the dispenser of FIG. 7 with a back portion of the housing removed, showing a more detailed view of how the filling inlet 220 and the flushing outlet 222 can connect to the reservoir.

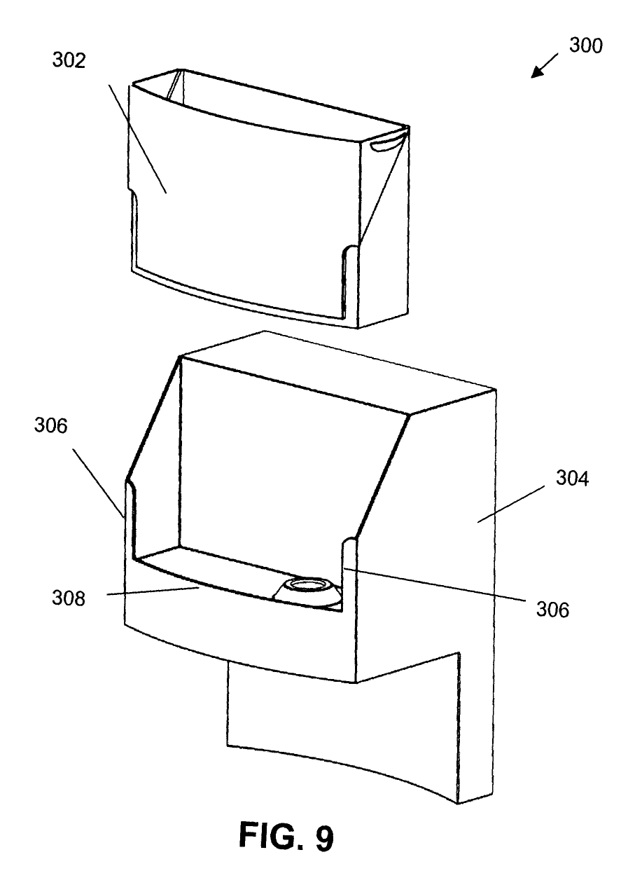

FIG. 9 is a front perspective view of an ozonated water dispenser 300 according to a further embodiment of the present invention with the reservoir 302 removed from the housing 304. In FIG. 9, the housing 304 includes a ledge 306 for gathering excess water, and lips 308 for receiving mating portions of the reservoir 302. The mating portions can be formed in the reservoir. The ledge and lips co-operate to prevent destruction and damage of the parts of the unit, as well as to make the reservoir difficult to remove, tip out, or pivot forward.

In a wall-mounted application, embodiments of the present invention can be provided for hand sanitizing in public institutions or areas, such as hospitals, nursing homes, stadiums, community centres, public washrooms, etc. With respect to ozonating or sanitizing different items, embodiments of the present invention can be provided in similar locations, but additionally can be provided in grocery stores so that customers can sanitize their produce before taking it home, thus increasing its shelf life. This can make shopping at certain locations more attractive, since the consumer can benefit from the ozonated water dispenser without having to purchase one. Of course, wall-mounted units or portable units can be used in households or in small enterprise environments.

Since the ozonated water dispenser is preferably able to dispense ozonated water at any time, it is advantageous that a high level of dissolved ozone in the water is maintained, preferably at all times. This can be accomplished by having the system run on a repetitive cycle.

A sample repetitive cycle will now be described, including an ozonation phase and a monitoring phase. The ozonated water dispenser processes water for an ozonation period, such as about two minutes, to get the dissolved ozone level up. The dispenser then shuts down for a monitoring period, such as approximately 5 minutes. During this monitoring period, or down cycle, the ozone level is slowly dropping in the water. If the ozone level drops below a set value, such as a minimum ozone concentration level, the sensor 138 will detect this and start another 2-minute cycle, i.e. will begin another ozonation phase for a duration of the ozonation period. If the ozone level is maintained for 5 minutes, then another 2-minute run cycle will begin. This can repeat on a continuous basis.

In other words, in an aspect, the present invention provides a method of regulating activation of an ozonated water dispenser, including the following steps: treating water during an ozonation phase for an ozonation period; shutting off the water treatment during a monitoring phase for a monitoring period; and beginning another ozonation phase if a monitored ozone level drops below an ozone concentration threshold.

The method can further include beginning another ozonation phase in response to expiry of an ozone cycle time period. The ozonation period can be about 2 minutes, and the monitoring period can be about 5 minutes.

Therefore, a preferred embodiment of the present invention uses both a timing method and the ozone sensor to determine if a run cycle, or ozonation phase, should occur. Embodiments of the present invention can employ one of the two methods, or both methods to ensure a high level of product performance.

The regulation of activation of the ozonated water dispenser is provided to keep the ozone level within a desired range. Of course, this desired range is only important during an operational mode. While the operational mode can be characterized by providing power to the unit (by plugging it in, or connecting a battery), the control board can also include a means to switch between an operational mode and a sleep mode. Switching can be based on programmed hours of operation for the operational mode, which can correspond to opening hours for a store or public facility, or meal times for a household or small enterprise environment. Advantageously, the control board can be pre-programmed with various settings, which can be modified and saved by a user.

The above-described embodiments of the present invention are intended to be examples only. Alterations, modifications and variations may be effected to the particular embodiments by those of skill in the art without departing from the scope of the invention, which is defined solely by the claims appended hereto.

1. An ozonated water dispenser comprising:
a reservoir for holding water, having an inlet and an outlet;
a pump connected to the outlet of the reservoir;
an ozonated water delivery means provided downstream from the pump to receive water from the pump and to dispense pressurized ozonated water, the ozonated water delivery means comprising:
a mister to dispense ozonated water in a mist; and
a control valve to restrict water flow in a water line in response to a dispensing request to build water pressure between the pump and the control valve to overcome a cracking pressure of the mister; and
a water ozonation means provided downstream from the ozonated water delivery means, and being in communication with the inlet of the reservoir to recirculate water, the water ozonation means including an ozone generator to convert oxygen into ozone, an ozone contacting device to mix the ozone with the water, and an off-gas unit to remove air and undissolved ozone.

2. The ozonated water dispenser of claim 1 further comprising an activation switch in electrical communication with the ozonated water delivery means, to initiate the dispensing request.

3. The ozonated water dispenser of claim 2 wherein the ozonated water delivery means dispenses water in response to actuation of the activation switch.

4. The ozonated water dispenser of claim 2 wherein the activation switch comprises an optical sensor.

5. The ozonated water dispenser of claim 1 wherein the control valve is a solenoid.

6. The ozonated water dispenser of claim 5 wherein the solenoid closes the water line in response to the dispensing request and opens the water line in response to termination of the dispensing request.

7. (canceled)

8. The ozonated water dispenser of claim 5 wherein the solenoid is integral with the mister.

9. The ozonated water dispenser of claim 1 wherein the mister comprises a dripless mister.

10. The ozonated water dispenser of claim 9 wherein the cracking pressure of the dripless mister is about 20 psi.

11. The ozonated water dispenser of claim 1 wherein the mister comprises a non-dripless mister.

12. The ozonated water dispenser of claim 11 wherein the cracking pressure of the non-dripless mister is about 10 psi.

13. The ozonated water dispenser of claim 11 further comprising a basin provided below the ozonated water delivery means to receive excess ozonated water after delivery, the basin including an outlet providing water back to the inlet of the reservoir.

14. (canceled)

15. The ozonated water dispenser of claim 1 wherein the ozonated water delivery means further comprises a dedicated pump to independently draw water out of the reservoir.

16. The ozonated water dispenser of claim 1 wherein the dedicated pump is connected to the reservoir by a second independent water line.

17. The ozonated water dispenser of claim 1 further comprising a water ozonation control means to automatically shut off the water ozonation means in response to expiry of an ozone cycle time period.

18. The ozonated water dispenser of claim 1 further comprising a water ozonation control means to control the water ozonation means in response to a sensed ozone concentration level.

19. The ozonated water dispenser of claim 18 wherein the water ozonation control means automatically turns on the water ozonation means in response to a determination that the sensed ozone concentration level is below an ozone concentration threshold.

20. The ozonated water dispenser of claim 18 wherein the water ozonation control means automatically shuts off the water ozonation means in response to a determination that the sensed ozone concentration level exceeds an ozone concentration limit.

21. The ozonated water dispenser of claim 1 further comprising an ozone concentration sensor provided near the reservoir to sense an ozone concentration in the water.

22. The ozonated water dispenser of claim 1 further comprising a filling inlet, connected to the reservoir, to receive water from an external water source.

23. The ozonated water dispenser of claim 22 further comprising a flushing outlet, connected to the reservoir, to flush water out of the reservoir.

24. The ozonated water dispenser of claim 1 further comprising check valves at an inlet and outlet of the ozone generator to prevent residual ozone gas diffusion to atmosphere when the dispenser is not running.

25. The ozonated water dispenser of claim 1 wherein the dispenser is provided in a housing, the housing and reservoir including mating portions to self-align the reservoir in the housing.

26. (canceled)

27. An ozonated water dispenser comprising:
a reservoir for holding water;
a water delivery pump connected to the reservoir via a water delivery path;
an ozonated water delivery means provided upstream from the water delivery pump in the water delivery path to receive water from the water delivery pump and to dispense pressurized ozonated water, the ozonated water delivery means comprising a mister to dispense ozonated water in a mist, the water delivery pump to turn on in response to a dispensing request to overcome a cracking pressure of the mister;
a water ozonation pump connected to the reservoir in a water ozonation path; and a water ozonation means provided downstream from the ozonated water delivery means, and being in recirculating communication with the reservoir to recirculate water.

28. The dispenser of claim 27 wherein the water ozonation means comprises an ozone generator to convert oxygen into ozone, an ozone contacting device to mix the ozone with the water, and an off-gas unit to remove air and undissolved ozone.
